(19) United States
(12) Patent Application Publication
(10) Pub. No.: US 2019/0392158 A1
(43) Pub. Date: Dec. 26, 2019

(54) MESSAGE EMISSION METHOD, RECEIVING METHOD, EMITTING DEVICE, RECEIVING DEVICE AND ASSOCIATED COMMUNICATION SYSTEM

(71) Applicant: THALES, Courbevoie (FR)

(72) Inventors: Antoine ROUX, Gennevilliers (FR); Hervé DELPEYRAT, Gennevilliers (FR)

(73) Assignee: THALES, Courbevoie (FR)

(21) Appl. No.: 16/466,996

(22) PCT Filed: Dec. 11, 2017
(86) PCT No.: PCT/EP2017/082277

§ 371 Date: Jun. 5, 2019

(30) Foreign Application Priority Data
Dec. 9, 2016 (FR) 16 01757

(51) Int. Cl. G06F 21/60; H04L 1/00; H04L 29/06

(52) U.S. Cl. CPC G06F 21/606; H04L 63/123; H04L 1/0057

(57) ABSTRACT

The invention relates to a method for emitting a message comprising data frames numbered and grouped into at least one block, the emission method being implemented by an electronic emission device and comprising:
the calculation of at least one recovery code for each block,
the emission of a message containing the block(s) and the, or each, corresponding calculated recovery code,
characterized in that the calculation of at least one recovery code comprises calculating the remainder of a Euclidean division of the number of each frame by at least predetermined number, and
each recovery code being obtained by EXCLUSIVE OR between the frames of the corresponding block for which the remainders of the Euclidean division of the number of said frames by the same predetermined number are equal.

The present invention relates to a method for emitting a message comprising data frames.

The invention also relates to a method for receiving a message emitted according to such a emission method.

The invention further relates to an electronic device for emitting a message comprising data frames.

The invention also relates to an electronic device for receiving a message sent by such an electronic emission device.

The invention also relates to an associated electronic communication system.

In general, sensitive information is processed and transmitted differently according to its level of classification. Information is said to be sensitive when its disclosure is likely to have an impact on entities concerned by such information.

As a result, the transmission of data between a system having a low level of confidentiality and a system having a high level of confidentiality is carried out by means of dedicated terminals and specialized gateways. Specialized electronic devices are used in order to ensure that no high-level confidentiality system data can leak to the low-level confidentiality system.

Such specialized devices are especially designed to transmit data unidirectionally from the low-level confidentiality system to the high-level confidentiality system. Thus, the data of the high level confidentiality system is not accessible by the low level system of confidentiality. However, when transmitting data, some data may be degraded or lost.

However, during the date transmission, it may happen that certain data is degraded or lost. Due to its isolation, the high-level confidentiality system does not have the ability to inform the low-level confidentiality system that data is degraded or missing.

A known solution to remedy such losses and/or data degradation is to transmit data in duplicate at different times.

However, such a emission has the effect of reducing the data rate by two, and is therefore not optimal. In addition, such a solution consumes a great deal of memory since the two copies of the same data are likely to be stored in memory upon reception, at least temporarily. Moreover, the probability of loss of a repeated frame remainder significant in the event of a degraded link, which makes such a solution unreliable.

There is, therefore, a need for the implementation of a system for reliably transmitting data at a higher transmission rate between two systems at different levels of confidentiality.

To this end, the object of the invention is a method for emitting a message comprising data frames, wherein the data frames are numbered and grouped into at least one block, and wherein the emission method is implemented by an electronic emission device and comprises:
calculation of at least one recovery code for each block,
emission of a message containing the block(s) and the, or each, corresponding calculated recovery code,

wherein the calculation of at least one recovery code comprises calculating the remainder of a Euclidean division of the number of each frame by at least a predetermined number, and

each recovery code is obtained by EXCLUSIVE OR between the frames of the corresponding block for which the remainders of the Euclidean division of the number of the said frames by the same predetermined number are equal.

According to other advantageous aspects of the invention, the emission method comprises one or more of the following characteristics, taken separately or in any technically feasible combination:
several predetermined numbers are used when calculating the, or each, recovery code, and the predetermined numbers are mutually prime numbers;
the product of the predetermined numbers is greater than or equal to the number of data frames contained in the message;
the number of recovery codes corresponding to each block is equal to the sum of the predetermined number(s), wherein this sum is equal to the predetermined number when it is unique.

The invention also relates to a method for receiving a message emitted according to the emission method as described above, wherein the reception method is implemented by an electronic reception device and comprises:
reception of data frames from among the data frames of the emitted message and recovery codes from among the recovery codes of the emitted message, wherein the number of received data frames is less than or equal to the number of emitted data frames,
determination of a missing data frame by EXCLUSIVE OR between a recovery code for which only the said frame is missing and the frames received for the said recovery code.

According to other advantageous aspects of the invention, the message comprises a first verification code calculated for each frame, according to a calculation law, wherein the method further comprises:
the calculation according to the calculation law of a second verification code for each frame, and comparison of the second verification code with the first verification code, and
the deletion, among the data frames received, of the frames whose second verification code is different from the first verification code.

The invention also relates to an electronic device for emitting a message comprising data frames, wherein the data frames are numbered and grouped into at least one block, and wherein the electronic emission device comprises:
a first calculation module configured to calculate at least one recovery code for each block,
a emission module configured to receive a message containing the block(s) and the, or each, corresponding calculated recovery code,

wherein the first calculation module is configured to calculate the remainder of a Euclidean division of the number of each frame by at least a predetermined number, and then to calculate each EXCLUSIVE OR recovery code between the frames of the corresponding block for which the remainders of the Euclidean division of the number of the said frames by the same predetermined number are equal.

The invention further relates to an electronic device for receiving a message emitted by the electronic emission device as described above, wherein the electronic reception device comprises:
a reception module configured to receive data frames from among the data frames of the emitted message, and to receive recovery codes from among the recovery codes of the emitted message, wherein the number of received data frames is less than or equal to the number of frames of emitted data,
a determination module configured to determine a missing data frame by EXCLUSIVE-OR between a recovery code for which only the said frame is missing and the frames received for the said recovery code, wherein the determined frame is then considered as a data frame received by the reception module.

The invention also relates to an electronic communication system comprising an electronic emission device and an electronic reception device as described above.

According to other advantageous aspects of the invention, the electronic communication system comprises the following characteristic:
the electronic emission device has a first level of confidentiality while the electronic reception device has a second level of confidentiality, wherein the first level of confidentiality is different from the second level of confidentiality.

Other features and advantages of the invention will become apparent upon reading the description which follows, given solely by way of a non-limiting example, and with reference to the appended drawings, wherein:

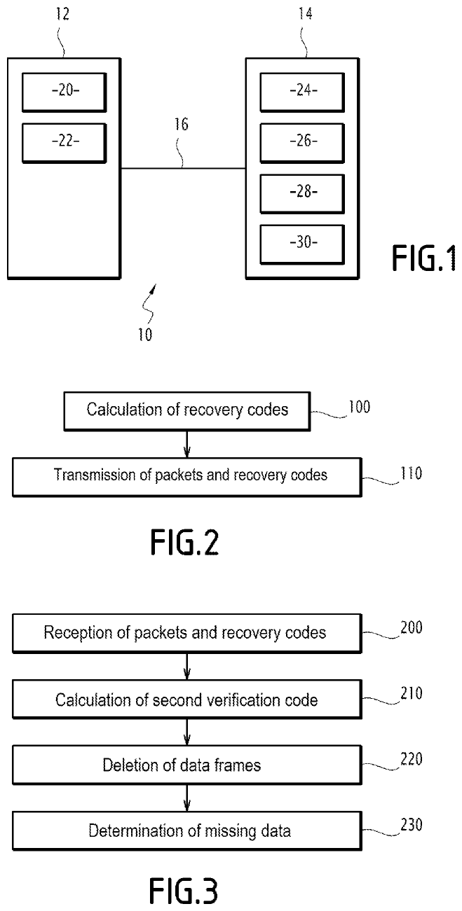

FIG. 1 shows a schematic representation of an electronic communication system according to the invention,

FIG. 2 shows a flowchart of a emission method according to the invention, and

FIG. 3 shows a flowchart of a reception method according to the invention.

In FIG. 1, an electronic communication system 10 is configured to implement a method of communicating a message comprising data frames. The expression “communicate a message” is understood to mean the emission of the message from a emission point to a reception point.

The data frames relate to the same set of data from an initial file. A data frame is a fragment of the initial file. The data frames are preferably the same size.

The data of the initial file and the data frames are preferably in the binary format.

The data frames are numbered. The data frame numbers are preferably positive integers.

In addition, the data frames are grouped into at least one block. When the data frames are grouped into several blocks, the blocks preferably have the same size. Each block of data is also called a data packet, and the term packet is then analogous to the term block within the meaning of the invention.

The data frames are, for example, data frames compliant with the UDP (User Datagram Protocol).

The communication system 10 comprises an electronic emission device 12, an electronic reception device 14 and a link 16 connecting the electronic emission device 12 to the electronic reception device 14.

The electronic emission device 12 is configured to implement a method for emitting a message comprising data frames, which will be described in more detail in the following description. The electronic emission device 12 has a first level of confidentiality.

A confidentiality level groups together a specific category of information. Confidentiality levels are generally selected from a group consisting of: very secret, secret, confidential, restricted and unclassified.

Classified information is sensitive information whose access is restricted by law or regulation to a specific group of people. Domains are, for example, systems for developing an air, space, sea, land, or cyber situation, or government organizations, regardless of their level of confidentiality.

The electronic emission device 12 comprises a first calculation module 20 and a emission module 22.

Optionally, the electronic emission device 12 may further comprise a formatting module for the data of the initial file. The formatting module is configured to split the original file into frames of the same size and to number the said data frames. The formatting module is also configured to group the data frames in at least one block.

The electronic emission device 12 comprises, for example, a first information processing unit (not shown) formed by a first memory and a first processor associated with the first memory.

The electronic reception device 14 is configured to implement a method of receiving a emitted message, which will be described in more detail in the following description.

The reception device 14 has a second level of confidentiality.

The second level of confidentiality is preferably different from the first level of confidentiality. For example, the second level of confidentiality may be a higher level of confidentiality than the first level of confidentiality. For example, the first level of confidentiality of the emitting device 12 is a confidential defense level, while the second level of confidentiality of the reception device 14 is a secret defense level.

In the example of FIG. 1, the reception device 14 comprises a reception module 24, a second calculation module 26, a deletion module 28 and a determination module 30.

The electronic reception device 14 comprises, for example, a second information processing unit (not shown) formed by a second memory and a second processor associated with the second memory.

The first calculation module 20 is configured to calculate at least one recovery code for each block. The calculation of at least one recovery code by the first calculation module 20 comprises calculating the remainder of a Euclidean division of the number of each frame by at least a predetermined number.

The, or each, predetermined number is an integer greater than or equal to one. The, or each, predetermined number is, for example, provided by the user with the initial file comprising the data frames to be transmitted.

Preferably, when several predetermined numbers are used by the first calculation module 20 for calculating each recovery code, the said predetermined numbers are mutually prime.

The first calculation module 20 is configured to calculate, for each block, a number of recovery codes equal to the sum of the predetermined number(s). In the case where the predetermined number is unique, the said sum is equal to the predetermined number.

For example, when the predetermined numbers are the numbers 2, 3 and 5 which are mutually prime numbers, the first calculation module 20 is able to calculate 10 recovery codes per block.

Advantageously, the sum of the predetermined numbers is less than or equal to 0.3 times the number of data frames contained in the message, preferably less than or equal to 0.2 times the said number of frames.

Alternatively or additionally, the product of the predetermined numbers is greater than or equal to the number of data frames contained in the message.

The first calculation module 20 is configured to calculate each EXCLUSIVE OR recovery code between the frames of the corresponding block for which the remainders of the Euclidean division of the number of the said frames by the same predetermined number are equal.

The EXCLUSIVE OR operator, also called XOR operator, is a binary operator that takes as argument two Boolean numbers and returns the EXCLUSIVE OR of the said numbers.

The EXCLUSIVE OR operator is a commutative and associative operator.

The calculation of an EXCLUSIVE OR between two frames amounts to calculating the EXCLUSIVE OR between the bits of the two frames. Such an operation is fast in terms of calculation time.

In the rest of the description, the frames of each block for which the remainders of the Euclidean division of the number of the said frames by the same predetermined number are equal are called “paired frames”.

The emission module 22 is configured to transmit a message containing the block(s) and the corresponding calculated recovery code.

The first calculation module 20 and the emission module 22 are, for example, each in the form of software. The first memory of the first information processing unit is then able to store first calculation software configured to calculate at least one recovery code, and emission software configured to transmit a message containing the block(s) and the calculated recovery code(s). When the emission module 22 is implemented in software form, it is, for example, also coupled to a emitter, such as a radio emitter.

Alternatively, the first calculation module 20 and the emission module 22 are each made in the form of a programmable logic component, such as an FPGA (Field-Programmable Gate Array); or in the form of a dedicated integrated circuit, such as an ASIC (Application-Specific Integrated Circuit). When the emission module 22 is implemented in the form of a programmable logic component or a dedicated integrated circuit, it is coupled to a separate emitter, such as a radio emitter, or integrated into the emitter and then implemented as the programmable logic component or the dedicated integrated circuit.

The reception module 24 is configured to receive data frames emitted by the emission module 22 of the emission device 12. The reception module 24 is also configured to receive recovery codes emitted by the emission module 22.

The number of received data frames is less than or equal to the number of data frames emitted. The number of recovery codes received is less than or equal to the number of recovery codes emitted. In fact, it is possible that data frames and/or recovery codes may have been lost between the emission of the message by the emission device 12 and the reception of the corresponding message by the reception device 14.

The data frames emitted and not received by the reception module 24 are called missing data frames.

The second calculation module 26 and the deletion module 28 are optional modules.

The second calculation module 26 and the deletion module 28 are used when the message includes a first verification code for each frame.

The first verification code is specific to each frame. The first verification code is calculated for each frame according to a calculation law. The first verification code is a means for checking the integrity of the transmitted data frames. The first verification code comprises redundant elements with respect to the frame, making it possible to detect transmission errors or degradation of the corresponding data frame. The first verification code is, for example, a CRC code (Cyclic Redundant Check).

For each frame received by the reception module 24, the second calculation module 26 is able to calculate, according to the calculation law, a second verification code. For each frame, the second calculation module 26 is also configured to compare the calculated second verification code with the corresponding first verification code.

The deletion module 28 is configured to delete, among the received data frames, the data frames whose second verification code is different from the first verification code. Deleted data frames are considered to be missing data frames.

The determination module 30 is configured to determine a missing data frame by EXCLUSIVE OR between a recovery code for which only the said frame is missing and the frames received for the said recovery code.

The determination made by the determination module 30 is based on the fact that the EXCLUSIVE OR is commutative and associative. Thus, when a single frame is missing in a recovery code and the said recovery code has been received by the reception module 24, the missing data frame is equal to the EXCLUSIVE OR between the said recovery code and the data frames. received and not missing of the said code.

Specifically, the determination module 30 is configured to determine the set of missing data frames until a recovery condition is fulfilled.

The recovery condition is fulfilled when the number of missing data frames forming each recovery code is different from 1. In other words, as long as there is only one missing data frame for at least one recovery code, the recovery condition is not fulfilled, and it is still possible to recover at least one missing data frame.

The reception module 24, the determination module 30, and, optionally, the second calculation module 26 and the deletion module 28, are, for example, each made in the form of software. The second memory of the second information processing unit is then able to store reception software configured to receive data frames and determination software configured to determine at least one missing data frame. When the reception module 24 is implemented in software form, it is, for example, further coupled to a receiver, such as a radio receiver. Optionally the second memory may be able to store second calculation software configured to calculate a second verification code according to a calculation law, and to compare the calculated second verification code with a first verification code. Optionally, the second memory 74 may be able to store deletion software configured to delete the frames whose second verification code is different from the corresponding first verification code.

Alternatively, the reception module 24, the determination module 30, and, optionally, the second calculation module 26 and the deletion module 28, are each made in the form of a programmable logic component, such as an FPGA; or in the form of a dedicated integrated circuit, such as an ASIC. When the reception module 24 is made in the form of a programmable logic component or a dedicated integrated circuit, it is coupled to a separate receiver, such as a radio receiver, or integrated into the receiver, which is then embodied as a programmable logic component or dedicated integrated circuit.

The link 16 is configured to ensure the transmission of messages between the electronic emission device 12 and the electronic reception device 14.

In the case where the first confidentiality level of the emission device 12 is lower than the second confidentiality level of the reception device 14, the link 16 is a unidirectional transmission link allowing message transfer only from the emission device 12 to the reception device 14.

Alternatively, when there is no constraint on the confidentiality level of the emission and reception devices 14, or when the emission devices 12 and reception devices 14 are of the same level of confidentiality, the link 16 comprises one or more unidirectional transmission links, or one or more bidirectional transmission links.

The link 16 comprises, for example, an optical diode. Alternatively, the link 16 may comprise, for example, a software diode. A software diode is a diode comprising a software component configured to allow only unidirectional data communication, i.e. it is configured to allow the flow of data in one direction, and to prohibit the flow of data in the other direction, i.e. to prohibit the circulation of data in the direction opposite to the authorized direction of circulation of the data.

A message communication method will now be described with reference to FIGS. 2 and 3.

The communication method comprises a method for emitting a message comprising data frames and a method for receiving the message emitted by such a emission method.

The emission method is illustrated in FIG. 2.

The emission method is implemented by the electronic emission device 12.

Initially, an initial file is provided to the emission device 12. The initial file includes data frames numbered and grouped in blocks.

The emission method comprises a calculation step 100, in which the first calculation module 20 calculates at least one recovery code for each block.

For this, the first calculation module 20 calculates the remainder of a Euclidean division of the number of each frame by a predetermined number.

Then, the first calculation module 20 calculates each EXCLUSIVE OR recovery code between paired frames.

In what follows, an example is given of the calculation of recovery codes for a block comprising 30 numbered frames. The frames are denoted by “Ti”, where i denotes the number of the frame, and wherein i ranges from 0 to 29. The predetermined number used to calculate the recovery code is 2.

In the example, the first calculation module 20 calculates a number of recovery codes for the block equal to the predetermined number, i.e. 2 recovery codes.

From the predetermined number equal to 2, the first calculation module 20 is configured to calculate the following 2 recovery codes:

C(2,0)=T0\hat{ }T2\hat{ }T4\hat{ }T6\hat{ }T8\hat{ }T10\hat{ }T12\hat{ }T14\hat{ }T16\hat{ }T18\hat{ }T20\hat{ }T22\hat{ }T24\hat{ }T26\hat{ }T28

C(2,0)=T1\hat{ }T3\hat{ }T5\hat{ }T7\hat{ }T9\hat{ }T11\hat{ }T13\hat{ }T15\hat{ }T17\hat{ }T19\hat{ }T21\hat{ }T23\hat{ }T25\hat{ }T27\hat{ }T29,

where \hat{ } denotes the EXCLUSIVE OR operator.

The recovery code C(2,0) is obtained by EXCLUSIVE OR between the frames whose remainder of the Euclidean division of the number of the said frame by 2 is equal to 0. The recovery code C(2,1) is obtained by EXCLUSIVE OR between the frames whose remainder of the Euclidean division of the number of the said frame by 2 is equal to 1.

In the remainder of the description, the notation “C(m, n)” denotes a recovery code obtained by EXCLUSIVE OR between the frames of a block whose remainder of the Euclidean division of the number of the said frame by “m” is equal to “n”.

The emission method then comprises a emission step 110, in which the transmission module 22 sends a message containing the block(s) and the corresponding calculated recovery code.

The link 16 transmits the message from the transmission module 22 of the emission device 12 to the reception module 24 of the reception device 14.

The reception method is illustrated in FIG. 3.

The reception method comprises a reception step 200, in which the reception module 24 then receives data frames from among the data frames of the message sent by the emission module 22 of the emission device 12. The reception module 24 also receives recovery codes from among the recovery codes of the message emitted by the emission module 22.

When the message comprises, for each frame, a first verification code calculated according to a calculation law, the reception method comprises a step 210 of calculation and comparison, in which the second calculation module 26 calculates a second verification code for each frame received by the reception module 24 according to the calculation law.

For each received frame, the second calculation module 26 then compares the calculated second verification code with the corresponding first verification code.

The reception method then comprises a deletion step 220, in which the deletion module 28 deletes, among the received data frames, the data frames whose second verification code is different from the first verification code.

The reception method also comprises a determination step 230, in which the determination module 30 determines the missing data frames by EXCLUSIVE OR between a recovery code for which only the said frame is missing and the frames received for the said recovery code until the recovery condition is fulfilled.

In what follows, there an example is given for determining missing data frames for a message sent by the emission device 12 comprising a block of 100 frames and 23 recovery codes. The 100 frames are numbered T0 to T99. The 23 recovery codes were obtained before emission from the number of the said frames and the predetermined numbers 5, 7 and 11. The reception module 24 received all the recovery codes and all the frames except the frames T10, T11, T15, T22 and T60 that are missing.

In the example, the determination module 30 first determines the missing data frames for which only the said frame is missing in at least one recovery code. These are the frames T10, T15 and T60. In fact, the frame T10 may be determined from the recovery code C(11,10). The frame T15 may be determined from the recovery code C(11,4). The T60 frame may be determined from the recovery code C(11,5).

Then, during a second iteration, the determination module 30 determines the missing data frame T11. The frame T11 may be determined from the recovery code C(7,4). A person skilled in the art will observe that the determination of the frame T11 during the first iteration was not possible with the recovery code C(7,4) because the frame T60 that was part of the C(7,4) code, was also missing.

Then, during a third iteration, the determination module 30 determines the missing data frame T22. The frame T22 may be determined from the recovery code C(11,0). A person skilled in the art will observe that the determination of the frame T22 during the second iteration was not possible with the recovery code C(11,0). because the frame T11, part of code C(11,0), was also missing.

In the example, the recovery condition is fulfilled when the frame T22 is determined, i.e. when there is no longer a missing data frame.

Thus, the frames are re-paired, i.e. recovered, iteratively. The determination of a missing data frame during an iteration is likely to result in the determination of another missing data frame at the next iteration.

Thus, the communication system 10 according to the invention and the associated method implement the calculation of a recovery code using the characteristics of the EXCLUSIVE OR operator, whose calculation has the advantage of being fast.

The rate of recovery of missing data frames obtained with such a method is greater than the recovery rate obtained with the methods of the prior art as it is possible to process any amount of information and, potentially very important, in particular with a simple repetition of the frames.

In addition, the transmission rate is also greater than the transmission rate obtained with the methods of the prior art, in particular with a simple repetition of the frames. The useful ratio of the transmission rate obtained by implementing the present method is advantageously equal to the number of frames per data block divided by the sum of the number of frames per block and the number of codes.

The communication system and method according to the invention are particularly suitable for emitting messages from a device having a low level of confidentiality to a device having a high level of confidentiality, and for which the device of high level of confidentiality may not communicate with the outside.

Thus, this communication system and method makes it possible to transmit data between two systems of different levels of confidentiality in a reliable manner and with a high transmission rate.

1. Method for emitting a message comprising data frames, the data frames being numbered and grouped into at least one block, the emission method being implemented by an electronic emission device and comprising:
the calculation of at least one recovery code for each block,
the emission of a message containing the block(s) and the, or each, corresponding calculated recovery code,
wherein the calculation of at least one recovery code comprises calculating the remainder, of a Euclidean division of the number of each frame by at least a predetermined number, and
each recovery code is obtained by EXCLUSIVE OR between the frames of the corresponding block for which the remainders of the Euclidean division of the number of the said frames by the same predetermined number are equal.

2. Emission method according to claim 1, wherein a plurality of redetermined numbers are used in the calculation of the, or each, recovery code and the said predetermined numbers are mutually prime numbers.

3. Emission method according to claim 2, wherein the product of the predetermined numbers is greater than or equal to the number of data frames contained in message.

4. Emission method according to claim 1, wherein the number of recovery codes corresponding to each block is equal to the sum of the predetermined number(s), this sum being equal to the predetermined number when it is unique.

5. Method for receiving a message emitted according to the emission method according to claim 1, the reception method being implemented by an electronic reception device and comprising:
the reception of data frames among the data frames of the emitted message and recovery, codes among the recovery codes of the emitted message, the number of received data frames being less than or equal to the number of emitted data frames,
the determination of a missing data frame by EXCLUSIVE OR between a recovery code for which only the said frame is missing, and the frames received for the said recovery code.

6. Reception method according to claim 5, wherein the message comprises a first calculated verification code, for each frame, according to a calculation law, and
wherein the method further comprises:
the calculation according to the calculation law of a second verification code for each frame, and the comparison of the second verification code with the first verification code, and
the deletion, among the received data frames, of the frames whose second verification code is different from the first verification code.

7. Electronic emission device for sending a message comprising data frames, the data frames being numbered and grouped into at least one block, the electronic emission device comprising:
a first calculation module configured to calculate at least one recovery code for each block,
an emission module configured to receive a message containing the block(s) and the, or each, corresponding calculated recovery code,
wherein the first calculation module is configured to calculate the remainder of a Euclidean division of the number of each frame by at least a predetermined number, and then to calculate each recovery code by EXCLUSIVE OR between the frames of the corresponding block for which the remainders of the Euclidean division of the number of the said frames by the same predetermined number, are equal.

8. Electronic reception device for receiving a message from an electronic emission device according to claim 7, the electronic reception device comprising:
a reception module configured to receive data frames among the data frames of the emitted message and to receive recovery codes among the recovery codes of the emitted message, the number of received data frames being less than or equal to the, number of emitted data frames,
a determination module configured to determine a missing data frame by EXCLUSIVE OR between a recovery code for which only the said frame is missing and the frames received for the said recovery code, the determined frame being then considered as a data frame received by the reception module.

9. (canceled)

10. Electronic communication system according to claim 9, wherein the electronic emission device has a first level of confidentiality and the electronic reception device has a second level of confidentiality, wherein the first level of confidentiality is different from the second level of confidentiality.

11. Electronic communication system comprising:
electronic emission device for sending a message comprising data frames, the data frames being numbered and grouped into at least one block, the electronic emission device incliuding:
a first calculation module configured to calculate at least one recovery code for each block, and
an emission module configured to receive a message containing the block(s) and the, or each, corresponding calculated recovery code,
wherein the first calculation module is configured to calculate the remainder of Euclidean division of the number of each frame by at least a predetermined number, and then to calculate each recovery code by EXCLUSIVE OR between the frames of the corresponding block for which the remainders of the Euclidean division of the number of the said frames by the same predetermined number, are equal; and
an electronic reception device including:
a reception module configured to receive data frames among the data frames of the emitted message and to receive recovery codes among the recovery codes of the emitted message, the number of received data frames being less than or equal to the number of emitted data frames, and
a determination module configured to determine a missing, data frame EXCLUSIVE OR, between a recovery code for which only the said frame is missing and the frames received for the said recovery code, the determined frame being then considered as a data frame received by the reception module.
